(19) United States
(12) Patent Application Publication
(10) Pub. No.: US 2010/0086343 A1
(43) Pub. Date: Apr. 8, 2010

(54) REGULATOR STRUCTURE OF CARTRIDGE ROLLER BALL PEN

(75) Inventor: Shih-Lou LO, Taipei Hsien (TW)

Correspondence Address: RABIN & Berdo, PC, 1101 14TH STREET, NW, SUITE 500, WASHINGTON, DC, 20005, US

(73) Assignee: Hwan Yu Lung INC., Taipei Hsien (TW)

(21) Appl. No.: 12/396,648

(22) Filed: Mar. 3, 2009

(30) Foreign Application Priority Data
Oct. 6, 2008 (TW) 097217843

(51) Int. Cl. B43K 7/00

(52) U.S. Cl. 401/209

(57) ABSTRACT

A regulator structure of a cartridge roller ball pen is provided. The regulator structure is disposed within a front shell. A through hole is disposed in the center of the regulator for the disposal of a cotton core. A plurality of buffer regions formed of guide vanes is disposed on the surface of the regulator. A guide gap is disposed on an end of the regulator. Additionally, an ink discharge hole is disposed on the surface of the regulator. The ink discharge hole is communicated with the through hole. Thus, ink that expanded in volume due to heat is ink discharge buffered, and the ink is guided back into a cartridge ink box after the temperature is restored, so as to prevent the pollution resulted from ink ejected from the front end of the front shell, and to reduce the ink waste.

### BACKGROUND OF THE INVENTION

1. Field of Invention

The present invention relates to a regulator suitable for a cartridge roller ball pen, and more particularly to a regulator structure having an ink discharge buffering effect.

2. Related Art

Common writing utensils include pencils, ballpoint pens, pens, roller ball pens, and gel-ink pens, and the like. Each type of writing utensils has a respective use occasion. Taking a roller ball pen as an example, the writing is very fluent as a roller ball design of a ball point pen as well as fluid and fast-dry ink is used. For more effective use, a cartridge roller ball pen has been developed in recent years, which has an advantage that a cartridge ink box is replaceable, so as to decrease a use cost greatly, and conform to an environmental protection concept.

Referring to FIG. 1, for a conventional cartridge roller ball pen, a fixed base 2 is disposed at a rear end of a front shell 1. An ink guiding pipe 21 is disposed in the center of the fixed base 2 and is communicated with an ink channel 22 inside. A cotton core 3 for guiding ink is disposed at the other end of the ink channel 22. A roller ball pen nib 31 is then disposed at the other end of the cotton core 3. Thus, a cartridge ink box 4 is inserted behind the fixed base 2. The ink guiding pipe 21 may penetrate into the cartridge ink box 4, such that the ink may flow into the cotton core 3 through the ink channel 22. The ink is then guided to the roller ball pen nib 31 by the cotton core 3 for writing.

However, as such a cartridge roller ball pen does not have a proper ink discharge buffer structure, when the ball pen is placed in an environment having a relatively high temperature, the ink within the cartridge ink box 4 may be ejected from the ink channel 22 due to volume expansion, enter a space of the cotton core 3 and the front shell 1, or may even be ejected out of the front end of front shell 1 to cause pollution. Moreover, after the ink is ejected from the cartridge ink box 4, no matter the temperature is restored or not, the ink may not be withdrawn into the cartridge ink box 4. Thus, the ink may only get dried between the cotton core 3 and the front shell 1, causing unnecessary waste.

### SUMMARY OF THE INVENTION

The present invention is directed to provide a regulator structure of a cartridge roller ball pen, which is capable of buffering ink discharge, so as to avoid pollution due to ink ejection and reduce ink waste.

In order to achieve the objectives, a through hole is disposed in the center of the regulator, and a plurality of buffer regions formed of guide vanes is disposed on the surface of the regulator. Also, a guide gap is disposed at an end of the regulator. In addition, an ink discharge hole is disposed on the surface of the regulator. The ink discharge hole is communicated with the through hole. During assembling, a cotton core first passes through the through hole of the regulator. The regulator is then disposed within a front shell. The ink expanded in volume due to heat may be ejected from the ink discharge hole and flow into the buffer region. The ink gradually flows towards the front end of the pen nib along a guide channel formed of the guide vanes. As a guide channel of the longest distance is disposed in the present invention, a sufficient buffer region is provided to avoid the ink from being ejected directly. Moreover, when the temperature of the ink is restored, the ink may be guided back into a cartridge ink box by a guide gap design, so as to reduce the ink waste.

### BRIEF DESCRIPTION OF THE DRAWINGS

The present invention will become more fully understood from the detailed description given herein below for illustration only, and thus are not limitative of the present invention, and wherein:

FIG. 1 is a partial schematic structural view of a conventional cartridge roller ball pen;

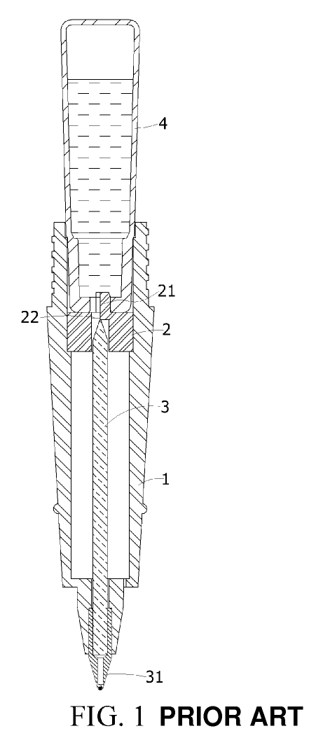

FIG. 2 is a three dimensional outside view of a preferred embodiment of the present invention before assembling;

FIG. 3 is a sectional view of the preferred embodiment of the present invention after assembling;

FIG. 4 is a three dimensional outside view of the preferred embodiment of the present invention after assembling;

FIG. 5 is a schematic view of buffering ink according to the preferred embodiment of the present invention; and

FIG. 6 is a three dimensional outside view of another preferred embodiment of the present invention.

### DETAILED DESCRIPTION OF THE INVENTION

The present invention will become more clearly understood from the following illustration with reference to the accompany drawings.

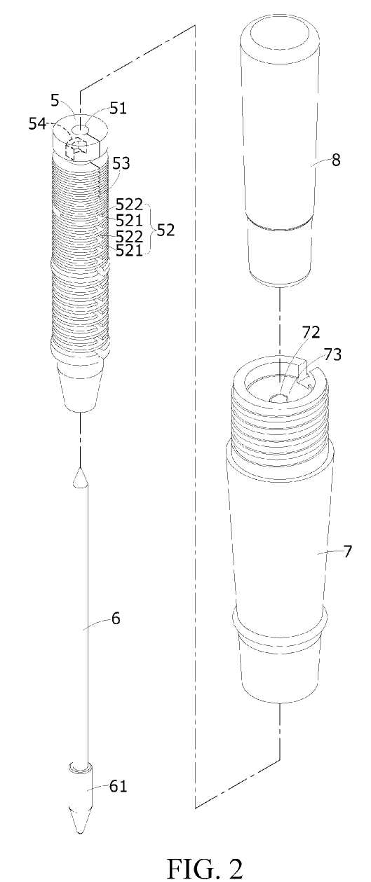

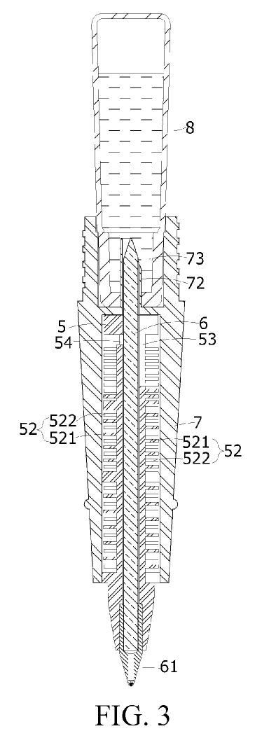

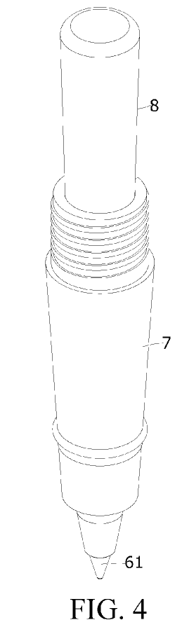

Referring to FIGS. 2-4, a through hole 51 is disposed in a center of a regulator 5 of the present invention, and a plurality of buffer regions 52 formed of a varying number of guide vanes 521 is disposed on the surface of the regulator 5. A guide hole 522 is disposed on each guide vane 521 of the buffer region, and a set angle is formed between guide holes 522 of two adjacent guide vanes 521. The set angle is 120-180 degrees. The set angle is preferably 180 degrees in practical use (as shown in the figures). Thus, a channel for guiding a flow is formed by arranging the guide vanes 521 having the guide holes 522 at intervals within the buffer region 52. Moreover, a guide gap 53 is disposed near the end of the regulator 5 and is communicated with the partial buffer region 52 for guiding the ink to flow back. In addition, an ink discharge hole 54 of a geometric shape (for example, a rectangle, a circle, or a polygon) is disposed on the surface of the regulator 5. The ink discharge hole 54 is communicated with the through hole 51 for use of ink discharge. The discharged ink may be guided into the buffer region 52 and flow within the guide channel of the buffer region 52. A position that the ink discharge hole 54 is disposed and a buffering effect of the discharged ink are closely related. Thus, the ink discharge hole 54 is near an end of the regulator 5 (as shown in the figures). Or, the ink discharge hole 54 may be disposed near a middle part of the regulator 5, such that the ink flows from the middle part towards tow ends of the regulator 5 to realize the buffering effect.

During assembling, a cotton core 6 passes through the through hole 51. A roller ball pen nib 61 is disposed at a front end of the cotton core 6. The three are then assembled into a front shell 7 of a cartridge roller ball pen. A fixed base 71 is disposed at an end of the front shell 7 for securing a position of the present invention. A protruding penetrative tube 72 is disposed in the center of the fixed base 71, such that the cotton core 6 passes through the tube 72. In addition, an oblique cut 73 is disposed at the periphery of the tube 72. When the cartridge roller ball pen is used, an opening of a cartridge ink box 8 is accurately inserted into the tube 72 of the front shell 7. A ball in the front end of the cartridge ink box 8 is pushed open by the tube 72, such that the ink is in communication with the cotton core 6. The ink is then guided to the roller ball pen nib 61 by way of the cotton core 6 for writing.

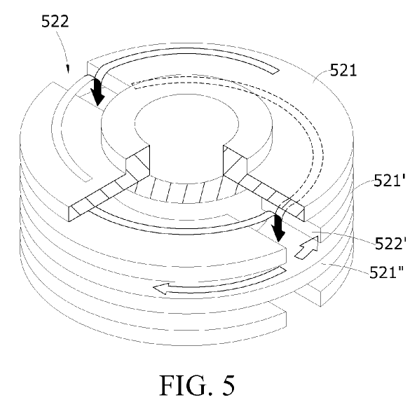

Referring to FIGS. 2 and 5, when the cartridge ink box 8 is heated, the pressure inside the cartridge ink box 8 will increase due to volume expansion of the ink. Thus, the pressure will be relieved with the ink through the ink discharge hole 54, such that the ink is discharged into the regulator 5 of the present invention. The ink flows in a guide channel formed inside the buffer region 52. The ink flows into a next guide vane 521′ through a guide hole 522 on the guide vane 521, and flows between the two guide vanes 521, 521′. When the ink reaches a guide hole 522′ of the next guide vane 521′, the ink will flow into still a next guide vane 521″. As an angle between the guide holes 522 of two guide vanes 521 of the present invention is set as 180 degrees, the ink flows in a longest distance, thus generating a most preferred buffering effect. Pollution resulted from the ink ejected from the front end of the front shell 7 directly is then avoided. When the temperature of the ink is restored, the ink inside the buffer region 52 will be recovered into the cartridge ink box 8 by the guide gap 53, so as to reduce ink waste.

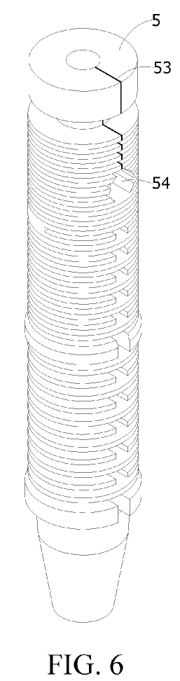

Moreover, referring to FIG. 6, the ink discharge hole 54 of the present invention may also be disposed on the guide gap 53, for example, on the front end of the guide gap 53, the rear end of the guide gap 53, or the middle position of the guide gap 53, and so on. The same ink discharge and pressure relief effect may be realized, and the difficulty of mould opening may be reduced to decrease manufacturing cost.

As discussed above, the present invention has the following advantages during implementation.
1. As shown in FIGS. 2-6, when the temperature of the cartridge ink box 8 increases, the present invention discharges ink and relieves pressure with the ink discharge hole 54. And the ink is guided into the guide channel formed inside the buffer region 52 for buffering flow. After the temperature is restored, the ink inside the buffer region 52 may be recovered by the disposal of the guide gap 53. Thus, the present invention may avoid pollution resulted from the ink ejected from the front end of the front shell 7, and may reduce ink waste.
2. Moreover, as the buffer region 52 of the present invention is formed of a plurality of guide vanes 521, and a set angle is formed on the guide holes 522 on adjacent guide vanes 521, which is preferably 180 degrees. The distance that the ink flows inside the buffer region 52 may be increased.
3. A disposal position of the ink discharge hole 54 of the present invention may have a variety of choices, thereby enhancing the ink discharge and pressure relief effect.

However, the above descriptions are merely preferred embodiments of the present invention, but not intend to limit the scope of the present invention. Some variations such as intervals of guide vanes, a disposal position of the ink discharge hole also are covered in the scope of the application. Thus, it is apparent to those skilled in the art that these equivalent or easy changes, such as the ink discharge hole is disposed at a rear end, middle part of the regulator, or a front end, rear end, or middle position of the guide gap, may be made, and the equivalent changes and modifications made without departing from the spirit of the present invention should all fall within the scope of the present invention.

In view of the above, the present invention meets the requirement of inventive step and also has industrial applicability. Therefore, the applicant files for a utility model patent according to the provisions of the Patent Act.

What is claimed is:

1. A regulator structure of a cartridge roller ball pen, disposed within a front shell, wherein a through hole is disposed in the center of the regulator for disposal of a cotton core, a plurality of buffer regions formed of a plurality of guide vanes is disposed on the surface of the regulator, a guide gap is disposed near an end of the regulator, and an ink discharge hole is also disposed on the surface of the regulator, and is communicated with the through hole.

2. The regulator structure for a cartridge roller ball pen according to claim 1, wherein a guide hole is disposed on each guide vane of the buffer region, and a set angle is formed between guide holes of two adjacent guide vanes.

3. The regulator structure for a cartridge roller ball pen according to claim 2, wherein the set angle is 120-180 degrees.

4. The regulator structure for a cartridge roller ball pen according to claim 1, wherein the ink discharge hole is rectangular.

5. The regulator structure for a cartridge roller ball pen according to claim 1, wherein the ink discharge hole is circular.

6. The regulator structure for a cartridge roller ball pen according to claim 1, wherein the ink discharge hole is polygonal.

7. The regulator structure for a cartridge roller ball pen according to claim 1, wherein the ink discharge hole is disposed near an end of the regulator.

8. The regulator structure for a cartridge roller ball pen according to claim 1, wherein the ink discharge hole is disposed near a middle part of the regulator.

9. The regulator structure for a cartridge roller ball pen according to claim 1, wherein the ink discharge hole is disposed at a front end of the guide gap.

10. The regulator structure for a cartridge roller ball pen according to claim 1, wherein the ink discharge hole is disposed at a rear end of the guide gap.

11. The regulator structure for a cartridge roller ball pen according to claim 1, wherein the ink discharge hole is disposed at a middle position of the guide gap.
